(19) United States
(12) Patent Application Publication
(10) Pub. No.: US 2009/0212962 A1
(43) Pub. Date: Aug. 27, 2009

(54) Oxygen Generating System with Self-Contained Electronic Diagnostics and Fault-Tolerant Operation

(75) Inventors: Michael P. Chekal, Brighton, MI (US); Dana G. Pelletier, Ortonville, MI (US)

Correspondence Address: CANTOR COLBURN, LLP, 20 Church Street, 22nd Floor, Hartford, CT, 06103, US

(73) Assignee: DELPHI TECHNOLOGIES, INC., Troy, MI (US)

(21) Appl. No.: 12/390,786

(22) Filed: Feb. 23, 2009

Related U.S. Application Data
(60) Provisional application No. 61/066,654, filed on Feb. 22, 2008.

(51) Int. Cl. G08B 17/10; G01N 1/00

(52) U.S. Cl. 340/632; 422/119

(57) ABSTRACT

A monitoring system for a portable oxygen generating system is provided. The system includes a system monitoring module that monitors an operational status of one or more components of the portable oxygen generating system. An alarm prioritization module determines an alarm priority level based on the operational status. An alarm system control module generates one or more alarm signals based on the alarm priority level.

### CROSS-REFERENCE TO RELATED APPLICATIONS

This application claims the benefit of U.S. Provisional Application No. 61/066,654 filed Feb. 22, 2008, the disclosure of which is incorporated by reference herein, in its entirety.

### BACKGROUND

The present disclosure relates generally to oxygen generating systems.

Oxygen generating systems are often used to produce an oxygen-enriched gas for a user. Oxygen generating systems typically include a gas fractionalization system configured to separate oxygen from other components (e.g., nitrogen) in a feed gas to produce the oxygen-enriched gas. The gas fractionalization system, for example, may include one or more sieve beds having a nitrogen-adsorption material disposed therein and configured to adsorb at least nitrogen from the feed gas.

Many oxygen generating systems also include a mechanism and/or process for detecting when one or more internal components and/or processes have failed or are simply not working properly. Upon detection of a failure, e.g., such detection mechanisms and/or processes tend to disable the entire oxygen generating system. Further, some of the current detection mechanisms and/or processes do not store information related to past detections of failures in the oxygen generating system, rendering a diagnosis of a problem a challenge in some instances.

### SUMMARY

A monitoring system for a portable oxygen generating system is provided. The system includes a system monitoring module that monitors an operational status of one or more components of the portable oxygen generating system. An alarm prioritization module determines an alarm priority level based on the operational status. An alarm system control module generates one or more alarm signals based on the alarm priority level.

These and other advantages and features will become more apparent from the following description taken in conjunction with the drawings.

### BRIEF DESCRIPTION OF THE DRAWINGS

Features and advantages of the present disclosure will become apparent by reference to the following detailed description and the drawings.

FIG. 1 is a schematic diagram of a portable oxygen generating system in accordance with an exemplary embodiment.

FIG. 2 is a dataflow diagram illustrating a controller of the exemplary portable oxygen generating system of FIG. 1 in accordance with an exemplary embodiment.

FIG. 3 is a flowchart illustrating a diagnostic method that can be performed by the controller of FIG. 2 in accordance with an exemplary embodiment.

### DETAILED DESCRIPTION

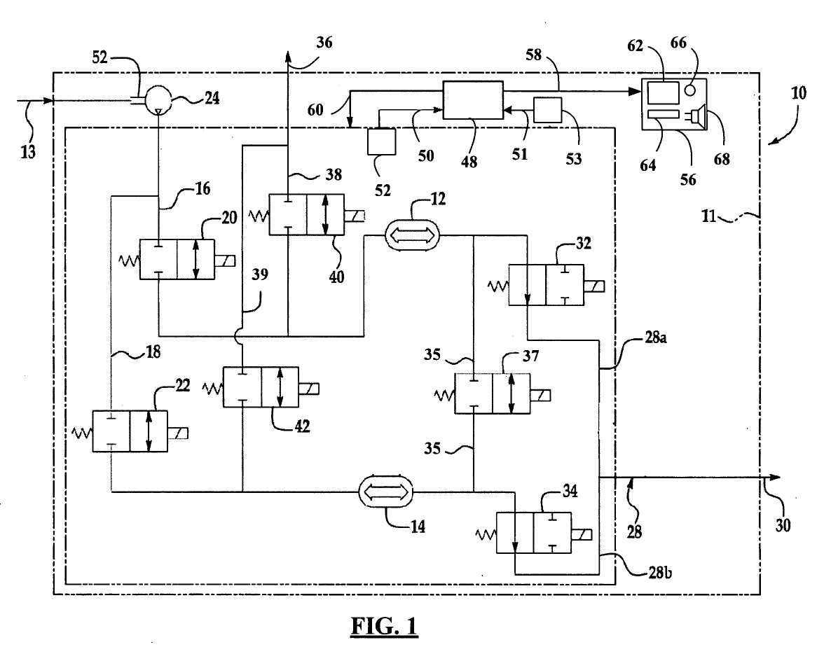

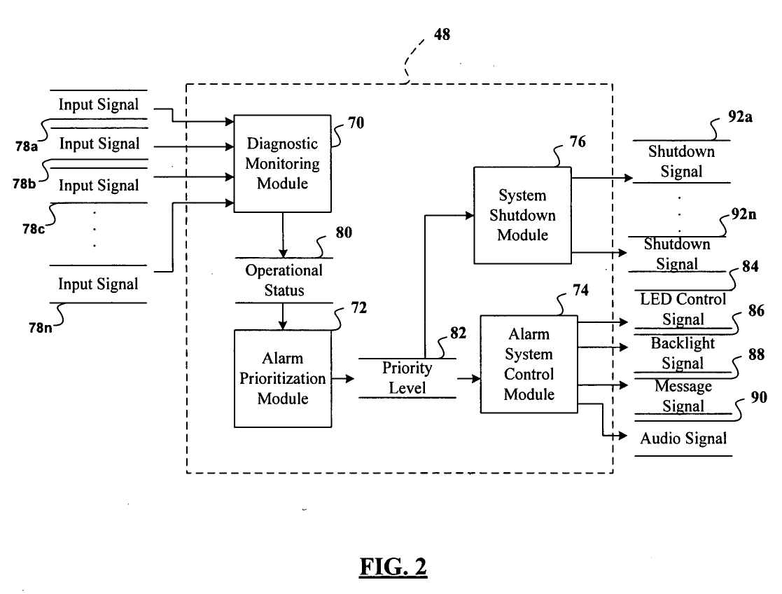

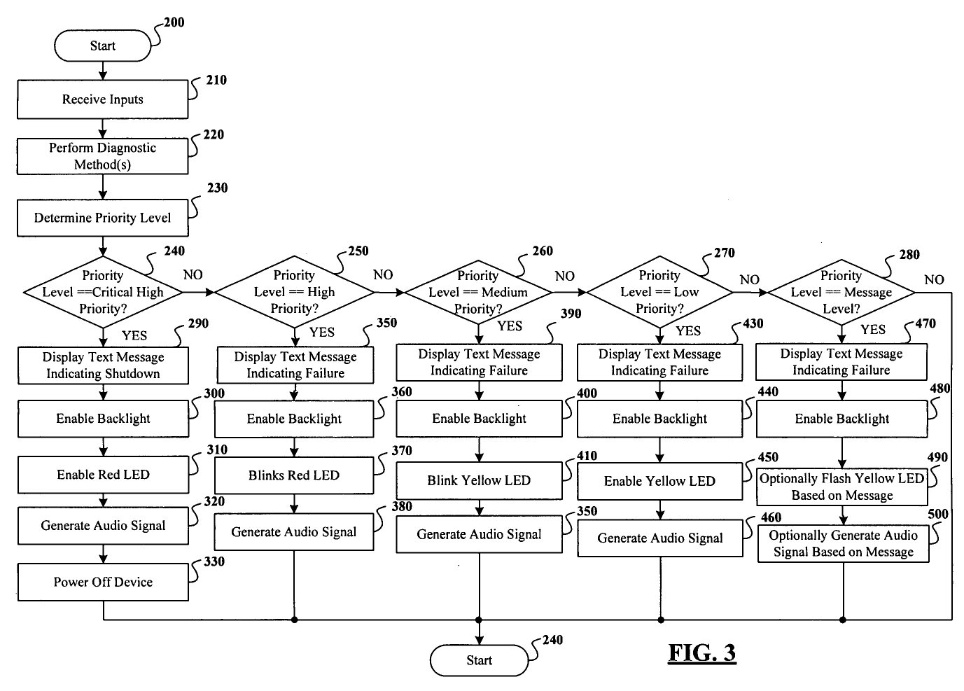

Referring now to the drawings, where the invention will be described with reference to specific embodiments, without limiting same, and where like numerals are use for like elements. An oxygen generating system or device 10, suitable for use with embodiments of the invention, is shown in FIG. 1. It is to be understood that any oxygen generating system may be suitable for use with the embodiments of FIGS. 2-3, various examples of which (not shown) are oxygen generating system(s) having fill valves (any suitable combination of 2-way, 3-way, 4-way valves, etc.), vent valves (any suitable combination of 2-way, 3-way, 4-way valves, etc.), a product tank(s), bleed orifice(s) and patient valving. Generally a nitrogen-adsorption process employed by the oxygen generating system may be a pressure swing adsorption (PSA) process or a vacuum pressure swing adsorption (VPSA) process, and such processes operate in repeating adsorption/desorption cycles.

The oxygen generating system 10, as shown in FIG. 1, includes a housing 11 having an inlet 13 formed therein. The inlet 13 is configured to receive feed gas from the ambient atmosphere, the feed gas including at least oxygen and nitrogen. The oxygen generating system 10 also includes at least one sieve bed. In the example shown in FIG. 1, the oxygen generating device 10 includes a first sieve bed 12 and a second sieve bed 14, each in selective fluid communication with the feed gas. In various embodiments, each of the first and second sieve beds 12, 14 are configured to selectively receive the feed gas during a predetermined supply period. The first and second sieve beds 12, 14 receive the feed gas via first and second supply conduits 16, 18, respectively.

The first and second supply conduits 16, 18 are generally operatively connected to respective first and second supply valves (or inlet valves) 20, 22. In a non-limiting example, the first and second supply valves 20, 22 are two-way valves. As provided above, the nitrogen-adsorption process employed by the oxygen generating system 10 operates via cycles, where one of the first or second sieve beds 12, 14 (e.g., the first sieve bed 12) vents purge gas (i.e. nitrogen-enriched gas), while the other of the first or second sieve beds 12, 14 (e.g., the second sieve bed 14) delivers oxygen-enriched gas to a user. During the next cycle, the functions of the respective sieve beds 12, 14 switch so that venting occurs from the sieve bed that previously was delivering oxygen-enriched gas (e.g., the second sieve bed 14), while oxygen enriched gas is delivered from the sieve bed that in the prior cycle was venting (e.g., the first sieve bed 12). Switching is accomplished by opening the respective feed gas supply valve 20, 22 while the other of the feed gas supply valves 20, 22 is closed.

More specifically, when one of the first or second sieve beds 12, 14 is receiving the feed gas, the respective one of the first or second supply valves 20, 22 is in an open position. In this case, the feed gas is prevented from flowing to the other of the first or second sieve beds 12, 14. In an embodiment, the opening and/or closing of the first and second supply valves 20, 22 may be controlled with respect to timing of opening and/or closing and/or with respect to the sequence in which the first and second supply valves 20, 22 are opened and/or closed.

In various embodiments, the feed gas is compressed via a compressor 24 prior to entering the first or second supply conduits 16, 18. In a non-limiting example, the compressor 24 is a scroll compressor. After receiving the compressed feed gas, the first and second sieve beds 12, 14 are each configured to separate at least most of the oxygen from the compressed feed gas to produce the oxygen-enriched gas. In various embodiments, the first and second sieve beds 12, 14 each include a nitrogen-adsorption material (e.g., zeolite, other similar suitable materials, and/or the like) configured to adsorb at least nitrogen from the feed gas. In a non-limiting example, the oxygen-enriched gas generated via either a PSA or VPSA process includes a gas product having an oxygen content ranging from about seventy percent to about one hundred percent of the total gas product. In another non-limiting example, the oxygen-enriched gas has an oxygen content of at least eighty-seven percent of the total gas product.

A user conduit 28 having a user outlet 30 is in alternate selective fluid communication with the first and second sieve beds 12, 14. The user conduit 28 may be formed from any suitable material, e.g., at least partially from flexible plastic tubing. In an embodiment, the user conduit 28 is configured substantially in a “Y” shape. As such, the user conduit 28 may have a first conduit portion 28a and a second conduit portion 28b, which are in communication with the first sieve bed 12 and the second sieve bed 14, respectively, and merge together before reaching the user outlet 30. The user outlet 30 is an opening in the user conduit 28 configured to output the substantially oxygen-enriched gas for use by the user. The user outlet 30 may additionally be configured with a nasal cannula, a respiratory mask, or any other suitable device (not shown), as desired.

The first conduit portion 28a and the second conduit portion 28b may be configured with a first user delivery valve 32 and a second user delivery valve 34, respectively. In the embodiment shown, the first and the second user valves 32, 34 are configured as two-way valves. Thus, it is contemplated that when the oxygen-enriched gas is delivered from one of the first and second sieve beds 12, 14, to the user conduit 28, the respective one of the first or second user valves 32, 34 is open. When the respective one of the first or second user valves 32, 34 is open, the respective one of the first or second feed gas supply valves 20, 22 is closed.

The nitrogen-adsorption process selectively adsorbs at least nitrogen from the feed gas. Generally, the compressed feed gas is introduced into one of the first or the second sieve beds 12, 14, thereby pressurizing the respective first or second sieve bed 12, 14. Nitrogen and possibly other components present in the feed gas are adsorbed by the nitrogen-adsorption material disposed in the respective first or second sieve bed 12, 14 during an appropriate PSA/VPSA cycle. The pressure of respective first or second sieve beds 12, 14 is released based upon a suitable trigger. The trigger may simply be a predetermined amount of time, or detection upon reaching a predetermined target pressure, or detection of an inhalation, and/or another suitable trigger.

In various embodiments, delivery of the oxygen-enriched gas occurs during or within a predetermined amount of time (i.e., a masked time) after the oxygen delivery phase from the respective first or second sieve bed 12, 14. For example, the oxygen generation system 10 may be configured to trigger an output of a predetermined volume of the oxygen-enriched gas from the sieve bed 12 upon detection of an inhalation by the user. As can be appreciated, detection of an inhalation may be accomplished any number of ways. The predetermined volume, which is at least a portion of the oxygen-enriched gas produced, is output through the user conduit 28 and to the user outlet 30 during an oxygen delivery phase.

Since a predetermined volume of gas is delivered to the user, it is contemplated that at least a portion of the oxygen-enriched gas will not be delivered to the user during or after the masked time to the user outlet 30. In various embodiments, the first and second sieve beds 12, 14 can be configured to transmit that “left-over” oxygen enriched gas, if any, to the other of the first or second sieve bed 12, 14. This also occurs after each respective oxygen delivery phase. The portion of the remaining oxygen-enriched gas is transmitted via a counterfill flow conduit 35. The transmission of the remaining portion of the oxygen-enriched gas from one of the first or second sieve beds 12, 14 to the other first or second sieve beds 12, 14 may be referred to as “counterfilling.”

As shown in FIG. 1, the counterfill flow conduit 35 is configured with a counterfill flow valve 37. In a non-limiting example, the counterfill flow valve 37 is a two-way valve. The counterfill flow valve 37 is opened to allow the counterfilling of the respective first and second sieve beds 12, 14.

At the same time or after the oxygen-enriched gas is being released to the user and after the counterfill is performed, the remaining nitrogen-enriched gas (including any other adsorbed components) can also be released from the respective first or second sieve bed 12, 14 and vented out of the oxygen generating system 10 through a vent port 36 that is in fluid communication with a vent conduit 38 and a vent conduit 39. As shown in FIG. 1, the nitrogen-enriched gas in the first sieve bed 12 is vented through a vent port/conduit 38 when a first vent valve 40 is open, and the nitrogen-enriched gas in the second sieve bed 14 is vented through a vent conduit 39 when a second vent valve 42 is open.

In various embodiments, a motor (not shown) drives one or more components of the oxygen generating system 10, such as, for example, the compressor 24, the sieve beds 12, 14, and the valves 20, 22, 32, 34, 40, 42. The motor is powered by a battery (not shown) located on or within the housing 11. In a non-limiting example, the motor is a DC brushless, three-phase. Further, the oxygen generating system 10 includes a fan (not shown) configured to cool the compressor 24 and the motor.

A controller 48 selectively controls the operation of one or more of the compressor 24, the first and second supply valves 20, 22, the first and second user delivery valves 32, 34, the first and second vent valves 40, 42, and the counterfill flow valve 37 via one or more control signals. As used herein, the terms controller or module refers to an application specific integrated circuit (ASIC), an electronic circuit, a processor (shared, dedicated, or grouped) and memory that executes one or more software or firmware programs, a combinational logic circuit, and/or other suitable components that provide the described functionality. In one non-limiting example, the controller 48 is a micro-controller including at least a central processing unit, a non-volatile memory device (e.g., Electrically Erasable Programmable Read-Only Memory (EEPROM)) a volatile memory device, and input/output devices.

The controller 48 controls the operation of the one or more components based on one or more sensor signals 50, 51 and/or serial communications (not shown) from other controllers (not shown). The sensor signals 50, 51 can be generated by one or more sensing devices 52, 53 of the oxygen generating system 10. The sensing devices 52, 53 measure various parameters relating to the operational status of the system components. In various embodiments, the sensing devices 52, 53 can include, but are not limited to, one or more sieve bed temperature sensors, sieve bed pressures sensors, ambient pressure sensors, ambient temperature sensors, oxygen sensors, and voltage sensors. As can be appreciated, one or more of the sensor signals 50, 51 can be processed by an Analog to Digital Converter (ADC) before passing to the controller 48.

The oxygen generating system 10 further includes an alarm system 56. In various embodiments, the alarm system 56 may include a visual alarm (e.g., a flashing light, an alpha-numeric message, or the like), an audible alarm (e.g., a beep), and/or other suitable mechanism for alerting a user of the system 10 that a problem exists. In one example, as shown in FIG. 1, the alarm system 56 includes a message display 62, a backlight 64 associated with the message display 62, an LED device 66, and an audio device 68. In addition to, or alternative to controlling the components of the oxygen generating system 10, the controller 48 diagnoses one or more components of the oxygen generating system 10 based on the one or more sensory signals 50, 51 and/or serial communications. In response to the diagnosis, the controller 48 selectively generates one or more alarm signals 58 to the alarm system 56 and one or more control signals 60 to selective components of the oxygen generating system 10.

The alarm signals 58, for example, can be generated to the message display 62, to the backlight 64, to the LED device 66, and/or to the audio device 68 to notify the user of specific operational conditions of the oxygen generating system thus, providing the user the opportunity to be aware of and correct any problems. The control signals 60, for example, can be generated to power off the oxygen generating system 10 in an orderly manner in order to protect components of the system 10.

Generally speaking, the controller 48 controls and diagnoses the operational status of the oxygen generating system 10 based on one or more diagnostic methods that provide intelligent detection of malfunctions, failures, or depletions of useful system operations or characteristics. This intelligent detection allows for relatively quick detection of potential system problems with relatively certain reactive functionality modes that allow the device to continue to operate. The diagnostic methods also store recent errors of the system 10 in a non-volatile error log. These stored errors are useful for interrogation by service personnel for substantially quick diagnosis of any potential problems with the system 10 and for tracking common problems to determine a relatively habitual problem that the system 10 might have.

Referring now to FIG. 2, the controller 48 is shown in more detail in accordance with an exemplary embodiment. In various embodiments, the controller 48 includes one or more sub-modules and datastores. The modules can be implemented as hardware and/or a combination of hardware and software. As can be appreciated, the sub-modules shown in FIG. 2 can be combined and/or further partitioned to similarly diagnose and control the oxygen generating system 10. In this example, the controller 48 includes a system monitoring module 70, an alarm prioritization module 72, an alarm system control module 74, and a system shutdown module 76.

The system monitoring module 70 receives as input the one or more input signals 78a-78n. The input signals 78a-78n can be generated by the sensing devices 52, 53 and/or by serial communications. Based on the input signals 78a-78n, the system monitoring module 70 monitors the operation of the oxygen generating system 10 (FIG. 1) and sets an operational status indicator 80 when potential malfunctions, failures, or depletions of system resources, operations, or characteristics occur.

In one example, the system monitoring module 70 monitors the oxygen generating system 10 (FIG. 1) by performing one or more diagnostic methods that detect a specific malfunction, that detect a specific failure, or that detect a depletion of a system resource. In various embodiments, the diagnostic methods can include, for example, but are not limited to, a battery empty method, a no pressure method, a vent failure method, a no pulse method, a counterfill failure method, a high temperature method, a memory failure method, a motor stall method, a compressor failure method, a fan failure method, a sieve bed leak method, a low oxygen method, a low pressure method, a temperature sensor failure method, temperature too hot method, a voltage sensor failure method, an oxygen sensor failure method, a compressor temperature sensor failure method, a vacuum failure method, a low batter method, a rapid breath method, a communication failure methods, a memory failure method, a barometric pressure sensor failure method, a batter communication failure method, a display failure, a replace P-filter method, a replace C-filter method, a wash 1-filter method, a replace battery method, a low clock batter method, and a resetting hours method.

With reference back to FIG. 1 and with continued reference to FIG. 2, the various diagnostic methods are described in accordance with exemplary embodiments. For example, the battery empty method detects when a voltage of the system 10 (FIG. 1) has fallen below a minimum safe operating voltage. In various embodiments, detection can be accomplished based on a voltage generated from a voltage sensor. In this case, the system monitoring module 70 sets the operational status 80 to indicate battery empty.

The no pressure method detects when a leak or obstruction in a fluid connection between the compressor 24 and the first or second sieve beds 12, 14. The no pressure method may also detect when a malfunction of at least one of the supply valves 20, 22. Such detection is generally made over several adsorption/desorption cycles to prevent a false alarm. The detection may be made using sieve bed pressure sensors that sense a pressure during a fill state of the cycle (i.e., when the sieve beds 12, 14 are pressurized). In this case, the system monitoring module 70 sets the operational status 80 to indicate no pressure.

The vent failure method detects a malfunction of at least one of the vent valves 40, 42 or an obstruction in at least one of the vent conduits 38, 39. Such detection is generally made over several adsorption/desorption cycles to prevent a false alarm. The detection may be made using sieve bed pressure sensors that sense sieve bed pressure during a vent state or user delivery state of the cycle (i.e., where the sieve beds 12, 14 are depressurized). In this case, the system monitoring module 70 sets the operational status 80 to indicate vent failure.

The no pulse method detects a malfunction of at least one of the user delivery valves 32, 34. Such detection is generally made over several cycles to prevent a false alarm. The detection may be made by using a breath detection sensor that senses a breath of the user during a user delivery state of the cycle. In this case, the system monitoring module 70 sets the operational status 80 to indicate no pulse.

The counterfill failure method detects a timeout of the system 10 during counterfilling thus, indicating a possible malfunction of the counterfill valve 37. Such detection is generally made over several cycles to prevent a false alarm. The detection may be made by using sieve bed pressure sensors that sense sieve bed pressure during a counterfill state of the cycle (i.e., when the pressure of the sieve beds 12, 14 are equalizing). In this case, the system monitoring module 70 sets the operational status 80 to indicate counterfill failure.

The high temperature method detects when an internal temperature of the system 10 is greater than the maximum allowable value. In this case, service may not be required if the temperature is greater than the maximum allowable value for a valid reason such as, for example, if the system 10 is located in an environment that is relatively hot. The system 10 is allowed to cool and an attempt restart the system 10 is made. The detection may be made using at least one temperature sensor of the system 10 and an ambient temperature sensor. In this case, the system monitoring module 70 sets the operational status 80 to indicate high temperature.

The memory failure method detects a malfunction in a write or readback function of memory in the controller 48 when the system 10 is powered up. In this case, the system 10 is considered to be unstable. The system monitoring module 70 sets the operational status 80 to indicate memory failure.

The motor stall method detects a repeated stalling of the motor. The method can detect the motor malfunction based on a maximum number of attempts to restart the motor. The detection may be made using a Hall-effect sensor to monitor the speed of the compressor 24 (e.g., in RPM) at times when the motor should be running. In this case, the system monitoring module 70 sets the operational status 80 to indicate motor stall.

The compressor failure method detects when the compressor 24 has exceeded a maximum instantaneous power consumption. For example the compressor power consumption is compared with the maximum instantaneous power consumption every 10 mS. In another example a detection that the compressor 24 has exceeded a maximum average power consumption, where the power consumption is checked once per minute. The detection may be made by monitoring a current consumption. In this case, the system monitoring module 70 sets the operational status 80 to indicate compressor failure.

The fan failure method detects when the fan 46 has stopped rotating. The detection may be made using a digital input connected to malfunction detection circuitry (not shown). In this case, the system monitoring module 70 sets the operational status 80 to indicate fan failure.

The sieve bed leak method detects a leak in the sieve beds 12, 14. The leak may occur in either a gasket or one of valve connections. If a leak is detected in both sieve beds 12, 14, the source may be either be the gasket between the sieve beds 12, 14, or the counterfill valve 37. The detection may be made by filling each sieve bed 12, 14 individually, allowing the zeolite to adsorb for a fixed period of time (which causes a change in pressure), saving a start pressure, waiting a fixed period of time, and then comparing the final pressure to the start pressure. In this case, the system monitoring module 70 sets the operational status 80 to indicate sieve bed leak.

The low oxygen method detects a low oxygen output. If no other alarms are present when the low oxygen output is detected, a corrupted sieve bed 12, 14 is present. The detection may be made by an oxygen sensor or algorithm that tracks the sieve bed pressures to detect corrupt nitrogen-adsorption material in the sieve beds 12, 14. In this case, the system monitoring module 70 sets the operational status 80 to indicate low oxygen.

The low pressure method detects when the system 10 is unable to maintain minimum operating pressures for proper oxygen output, which may result in less than desirable oxygen purity. This may be caused by various internal system problems, environmental conditions, high breath rate, or a combination thereof. The system 10 may need servicing if this condition occurs repeatedly. The detection may be made using sieve bed pressure sensors. In this case, the system monitoring module 70 sets the operational status 80 to indicate low pressure.

The temperature sensor failure method detects when temperature sensor readings are outside of an expected possible range. In various embodiments, a default of about thirty-five degrees Celsius is used for system performance calculations. In this case, the system 10 needs servicing. The system monitoring module 70 sets the operational status 80 to indicate temperature sensor failure.

The temperature too hot method detects when the internal temperature of the system 10 or the compressor power has reached a warning level (e.g. within a predetermined warning range). At this point, the target sieve bed pressure is reduced, which will reduce the oxygen output for a given flow setting. In this case, the system monitoring module 70 sets the operational status 80 to indicate temperature sensor failure.

The voltage sensor malfunction method detects when the system voltage readings are above or below an expected possible range. A default of about 15 volts is used in system calculations. In this case, the system 10 needs servicing. The system monitoring module 70 sets the operational status 80 to indicate voltage sensor malfunction.

The oxygen sensor malfunction method detects when the oxygen sensor has malfunctioned. In this case, a low oxygen alarm may not be detected unless a sieve bed corruption detection method is in use and the oxygen feedback control cannot be performed. In this case, the system monitoring module 70 sets the operational status 80 to indicate oxygen sensor malfunction.

The compressor temperature failure method detects when a compressor temperature sensor has malfunctioned. In this case, the fan speed control defaults to a full speed and compressor temperature warnings are based on old or default data. The system monitoring module 70 sets the operational status 80 to indicate compressor sensor failure.

The vacuum malfunction method detects when a vacuum valve or conduit has malfunctioned. In this case, the system 10 is running properly as long as there are no other errors. The detection may be made using sieve bed pressure sensors that sense a sieve be pressure during the adsorption/desorption cycle. In this case, the system monitoring module 70 sets the operational status 80 to indicate vacuum malfunction.

The low battery method detects when an estimated battery life at a current system setting has fallen below a predetermined time (e.g., seventeen minutes). The detection is automatically cleared and erased from memory when the battery is plugged in to recharge. The detection may be made using, e.g., smart battery communications. In this case, the system monitoring module 70 sets the operational status 80 to indicate low battery.

The check cannula method detects when inhalation has not occurred for a predetermined time (e.g., thirty seconds). The detection is automatically cleared and erased from the memory when a next inhalation is detected. The detection is made using a breath detection sensor and an internal timer. In this case, the system monitoring module 70 sets the operational status 80 to indicate check cannula.

The rapid breath method detects when the system 10 is unable to maintain target system pressures at the present breathing rate. This may result in an oxygen output less than a desirable percentage (e.g., ninety percent). The detection may be made by using sieve bed pressure sensors that sense a sieve bed pressure at an appropriate time during the adsorption/desorption cycle. In this case, the system monitoring module 70 sets the operational status 80 to indicate rapid breath. If conditions persist, the operational status may be replaced by a low oxygen.

The communication method detects when a watchdog circuit has reset the microprocessor. An external watchdog circuitry may be used which may be interrogated using serial communications to check for this malfunction. In this case, the system monitoring module 70 sets the operational status 80 to indicate communication error.

The manufacturing default method detects when the controller 48 could not read valid manufacturing data from memory (e.g., EEPROM). Default calibration values are used to correct the problem. The detection may be made by comparing checksum and signature data in memory (e.g., EEPROM). In this case, the system monitoring module 70 sets the operational status 80 to indicate manufacturing default.

The flash warning method detects when a manufacturing value for code checksum does not match a value stored in memory (e.g., EEPROM). The version of software used is suspected. In this case, the system monitoring module 70 sets the operational status 80 to indicate flash warning.

The memory malfunction detects when the controller 48 is unable to write to memory (e.g., EEPROM), which may affect hour counters and saving of flow settings. Default calibration values may be used to correct the problem. In this case, the system monitoring module 70 sets the operational status 80 to indicate memory malfunction.

The memory error method detects when the controller 48 is unable to write to EEPROM, which may affect hour counters and saving of flow settings. Again, default calibration values may be used to correct the problem. In this case, the system monitoring module 70 sets the operational status 80 to indicate memory error.

The barometric malfunction method detects when an ambient pressure sensor readings are outside of an acceptable range. A default pressure (e.g., about 14.7 psi) is used. In this case, the system monitoring module 70 sets the operational status 80 to indicate barometric malfunction.

The battery communication malfunction method detects when a battery communications over an internal interface has timed out. The system 10 will continue to operate normally, but the battery information is not available. In this case, the system monitoring module 70 sets the operational status 80 to indicate battery communication malfunction.

The display timeout method detects when communications between the controller 48 and the alarm system 56 has timed out. The system 10 continues to operate normally, but the display information may be intermittent. In this case, the system monitoring module 70 sets the operational status 80 to indicate display timeout.

The replace P-filter method detects when a patient output filter has reached its maximum number of hours. The counter for this alarm may be reset by the user when the alarm occurs, or is reset from a diagnostics menu when the filter is replaced. A warning is provided, for example, by displaying a message and sounding two beeps, before a deadline is reached so that replacement parts may be ordered. The detection is made using hour counters stored in memory (e.g., EEPROM). In this case, the system monitoring module 70 sets the operational status 80 to indicate replace P-filter.

The replace C-filter method detects when the compressor output filter has reached a maximum number of hours. The counter for this alarm may be reset by the user when the alarm occurs or from the diagnostics menu when the filter is replaced. A warning is provided, for example, by displaying a message and sounding two beeps before a deadline is reached, so that replacement parts may be ordered. The detection may be made using hour counters stored in memory (e.g., EEPROM). In this case, the system monitoring module 70 sets the operational status 80 to indicate replace C-filter.

The wash I-filter method detects when an input screen (filter) has reached its maximum number of hours. The counter for this alarm may be reset by the user when the alarm occurs, or is reset from the diagnostics menu when the filter has been washed. The detection may be made by using hour counters stored in memory (e.g., EEPROM). In this case, the system monitoring module 70 sets the operational status 80 to indicate wash I-filter.

The replace battery method detects when the battery has exceeded its maximum recharge cycles and should be replaced. The alarm for this indicator will automatically clear once a new battery is inserted and the system 10 is restarted. A warning is provided by sending a message and two beeps before a deadline is reached, so that replacement parts may be ordered. The detection may be made using smart battery communications. In this case, the system monitoring module 70 sets the operational status 80 to indicate replace battery.

The clock battery method detects when a batter of an internal real time clock is low and needs to be replaced. The alarm for this indicator will automatically clear once the battery is replaced by service personnel. The detection may be made using serial communications to a real rime clock chip. In this case, the system monitoring module 70 sets the operational status 80 to indicate replace clock battery.

The resetting hours method detects when an hour counter and an error log has been reset because valid signatures are not present on the memory log. A message is displayed after new software is loaded into the system 10. In this case, the system monitoring module 70 sets the operational status 80 to indicate resetting hours.

With reference back to FIG. 2, the alarm prioritization module 72 receives as input the operational status 80. The alarm prioritization module 72 classifies or prioritizes the malfunction, failure, or depletion of system resources, operations, or characteristics into a priority level 82 based on the operational status 80. The classification or priority level 82 allows for continuing use of the oxygen generating system 10 (FIG. 1) when the operational status 80 is non-critical.

In one example, the operational status is set to one of six predetermined operational categories including, but not limited to, normal operation, message, low priority, medium priority, high priority, and critical high priority. Under normal operation, the oxygen generating system 10 is considered to be working properly. The message category includes situations that warrant user notification. The low priority, the medium priority, and the high priority categories include situations that involve malfunctions and some failures. The critical high priority category includes situations that involve critical failures.

In one example, the priority level 82 is set to critical high priority when the operational status 80 indicates one or more of the following, the battery is empty, no pressure in the system, a vent failure, a no pulse, a counterfill failure, a high temperature, a memory failure, a motor stall, a compressor failure, or a fan failure. In one example, the priority level 82 is set to high priority when the operational status 80 indicates one or more of the following, a sieve bed leak, a low oxygen sensor, a low pressure, a temperature sensor failure, a temperature too hot, a voltage sensor failure, a compressor temperature sensor failure, or a vacuum failure.

In one example, the priority level 82 is set to medium priority when the operational status 80 indicates one or more of the following, a low battery, a check cannula, a rapid breath, a communications failure, a manufacturing default, a flash warning, a memory failure, or a memory error. In one example, the priority level 82 is set to low priority when the operational status 80 indicates one or more of the following, a replace P-filter, a replace C-filter, a wash I-filter, a replace battery, a low clock battery, or a resetting hours.

The alarm system control module 74 receives as input the priority level 82. Based on the priority level 82, the alarm system control module 74 selectively generates a message signal 88, a backlight signal 86, an LED signal 84, and/or and audio signal 90. The signals 84-90 activate their respective component of the alarm system 56 (FIG. 1).

In one example, when the priority level 82 is set to message, the alarm system control module 74 generates a message signal 88 to display text corresponding to the operational status 80 in the message display device 62 (FIG. 1); generates a backlight signal 86 to enable the backlight 64 (FIG. 1); optionally generates an LED signal 84 to enable the LED device 66 (FIG. 1) to blink yellow; and optionally generates an audio signal 90 to enable the audio device 68 (FIG. 1) to activate a chirping signal.

In one example, when the priority level 82 is set to low priority, the alarm system control module 74 generates a message signal 88 to display text corresponding to the operational status 80 in the message display device 62 (FIG. 1); generates a backlight signal 86 to enable the backlight 64 (FIG. 1); generates an LED signal 84 to enable the LED device 66 (FIG. 1) to display a yellow light; and generates an audio signal 90 to enable the audio device 68 (FIG. 1) to activate a beeping signal every so many minutes or seconds (e.g., every ten minutes).

In one example, when the priority level 82 is set to medium priority, the alarm system control module 74 generates a message signal 88 to display text corresponding to the operational status 80 in the message display device 62 (FIG. 1); generates a backlight signal 86 to enable the backlight 64 (FIG. 1); generates an LED signal 84 to enable the LED device 66 (FIG. 1) to display a yellow light; and generates an audio signal 90 to enable the audio device 68 (FIG. 1) to activate a beeping signal every so many minutes or seconds (e.g., every ten minutes).

In one example, when the priority level 82 is set to high priority, the alarm system control module 74 generates a message signal 88 to display text corresponding to the operational status 80 in the message display device 62 (FIG. 1); generates a backlight signal 86 to enable the backlight 64 (FIG. 1); generates an LED signal 84 to enable the LED device 66 (FIG. 1) to blink a red light; and generates an audio signal 90 to enable the audio device 68 (FIG. 1) to activate a beeping signal (e.g., ten beeps) every so many bursts of oxygen.

In one example, when the priority level 82 is set to critical high priority, the alarm system control module 74 generates a message signal 88 to display text corresponding to the operational status 80 in the message display device 62 (FIG. 1); generates a backlight signal 86 to enable the backlight 64 (FIG. 1); generates an LED signal 84 to enable the LED device 66 (FIG. 1) to display a red light; and generates an audio signal 90 to enable the audio device 68 (FIG. 1) to activate a beeping signal (e.g., ten beeps) every so many bursts of oxygen.

The system shutdown module 76 receives as input the priority level 82. Based on the priority level 82, the system shutdown module 76 selectively generates one or more shutdown signals 92a-92n to shutdown the oxygen generating system 10 (FIG. 1) in an orderly manner. Such signals 92a-92n are generally generated when the priority level 82 indicates critical high priority.

Referring now to FIG. 3, a flow chart illustrates a device monitoring and alarm method that can be performed by the controller of FIG. 2 in accordance with an exemplary embodiment. As can be appreciated in light of the disclosure, the order of operation within the method is not limited to the sequential execution as illustrated in FIG. 3, but may be performed in one or more varying orders as applicable and in accordance with the present disclosure.

As can be appreciated, the method can be scheduled to run based on predetermined events and/or at predetermined time intervals.

In one example, the method may begin at 200. The input signals 78a-78n are received at 210. One or more of the diagnostic methods as discussed above are performed at 220 to determine the operational status 80. In various embodiments, the operational status 80 is recorded a non-volatile memory module that is readable by a device external to the oxygen generating system 10. Based on the operational status 80, the priority level 82 is determined at 230. The priority level 82 is then evaluated at 240-280.

If the priority level 82 is set to crucial high priority at 240, the alarm system 56 (FIG. 1) is activated at 290-320. For example, at 290, a text message is displayed in the message display device 62 (FIG. 1) indicating the operational status 82 and a shutdown warning. The backlight 64 (FIG. 1) is enabled at 300. The LED device 66 (FIG. 1) is illuminated in red at 310. The audio device 68 (FIG. 1) sounds a beep at timed intervals at 320. Thereafter, the oxygen generating system 10 is powered down at 330 and the method ends at 340.

If, however, the priority level 82 is set to high priority at 250, the alarm system 56 (FIG. 1) is activated at 350-380. For example, at 350, a text message is displayed by the message display device 62 (FIG. 1) indicating the operational status 80. The backlight 64 (FIG. 1) is enabled at 360. The LED device 66 (FIG. 1) blinks red at 370. The audio device 68 (FIG. 1 sounds a beep at timed intervals at 380. Thereafter, the method may end at 340.

If, however, the priority level 82 is set to medium priority at 260, the alarm system 56 (FIG. 1) is activated at 390-420. For example, at 390, a text message is displayed by the text display device 62 (FIG. 1) indicating the operational status 80. The backlight 64 (FIG. 1) is enabled at 400. The LED device 66 (FIG. 1) blinks yellow at 410. The audio device 68 (FIG. 1) sounds a beep at timed intervals at 420. Thereafter, the method may end at 340.

If, however, the priority level 82 is set to low priority at 270, the alarm system 56 (FIG. 1) is activated at 430-460. For example, at 430, a text message is displayed by the text display device 56 (FIG. 1) indicating the operational status 80. The backlight 64 (FIG. 1) is enabled at 440. The LED device 66 (FIG. 1) illuminates a yellow light at 450. The audio device sounds a beep at timed intervals at 460. Thereafter, the method may end at 340.

If, however, the priority level is set to message at 280, the alarm system is activated at 470-500. For example, at 470, a text message is displayed indicating the operational status. The backlight is enabled at 480. The LED optionally flashes yellow based on the message at 490. The audio device 68 (FIG. 1) optionally sounds a chirp at timed intervals based on the message at 500. Thereafter, the method may end at 340.

If, however, the priority level 82 is not set to critical high priority, high priority, medium priority, low priority, or message at 240-280, the operational status 80 is normal operation and the alarm system 56 (FIG. 1) is not activated. The method may end at 340.

While several embodiments have been described in detail, it will be apparent to those skilled in the art that the disclosed embodiments may be modified and/or other embodiments may be possible. Therefore, the foregoing description is to be considered exemplary rather than limiting.

What is claimed is:

1. A monitoring system for a portable oxygen generating system, comprising:
a system monitoring module that monitors an operational status of one or more components of the portable oxygen generating system;
an alarm prioritization module that determines an alarm priority level based on the operational status; and
an alarm system control module that generates one or more alarm signals based on the alarm priority level.

2. The monitoring system of claim 1, wherein the alarm priority level is at least one of critical high priority, high priority, medium priority, low priority, and message priority.

3. The monitoring system of claim 1, wherein the alarm system control module generates a message signal to message display of the portable oxygen generating system based on the priority level.

4. The monitoring system of claim 1, wherein the alarm system control module generates a backlight control signal to a backlight of a message display of the portable oxygen generating system based on the priority level.

5. The monitoring system of claim 1, wherein the alarm system control module generates an LED control signal to an LED of the portable oxygen generating system based on the priority level.

6. The monitoring system of claim 1, wherein the alarm system control module generates an audio control signal to an audio device of the portable oxygen generating system based on the priority level.

7. The monitoring system of claim 1, further comprising a system shutdown control module that generates one or more system control signals to shutdown the portable oxygen generating system based on the priority level.

8. The monitoring system of claim 1, wherein the alarm prioritization module selectively stores the priority level in memory that is readable by a device external to the portable oxygen generating system.

9. A method for a monitoring system of a portable oxygen generating system, comprising:
monitoring an operational status of one or more components of the portable oxygen generating system;
determining an alarm priority level based on the operational status; and
generating one or more alarm signals based on the alarm priority level.

10. The method of claim 9, wherein the alarm priority level is at least one of critical high priority, high priority, medium priority, low priority, and message priority.

11. The method of claim 9, further comprising generating a message signal to message display of the portable oxygen generating system based on the priority level.

12. The method of claim 9, further comprising generating a backlight control signal to a backlight of a message display of the portable oxygen generating system based on the priority level.

13. The method of claim 9, further comprising generating an LED control signal to an LED of the portable oxygen generating system based on the priority level.

14. The method of claim 9, further comprising generating an audio control signal to an audio device of the portable oxygen generating system based on the priority level.

15. The method of claim 9, further comprising generating one or more system control signals to shutdown the portable oxygen generating system based on the priority level.

16. The method of claim 9, further comprising selectively storing the priority level in memory that is readable by a device external to the portable oxygen generating system.

17. A portable oxygen generating system, comprising:
a housing;
a controller operatively disposed within the housing;
an alarm disposed on or within the housing and operatively connected to the controller; and
at least one sensing device disposed within the housing and configured to monitor an operating condition of the portable oxygen generating system and produce a signal receivable by the controller, and
wherein the controller determines an operational status of the portable oxygen generating system, adjusts a functionality of the portable oxygen generating system in response to the operational status, and activates an alarm protocol based on the operational status.

18. The portable oxygen generating system of claim 17, wherein the at least one sensing device includes at least one of a sieve bed temperature sensor, a sieve bed pressure sensor, an ambient pressure sensor, an ambient temperature sensor, an oxygen sensor, and a voltage sensors.

19. The portable oxygen generating system of claim 17, wherein the at least one operational status category includes at lest one of critical high priority, high priority, medium priority, low priority, and message.

20. The portable oxygen generating system of claim 17, wherein adjusting the functionality of the pulsed oxygen generator includes at least one of shutting down the pulsed oxygen generator in a predetermined manner, continuing operation of the pulsed oxygen generator, substituting a default value for a monitored value, and substituting a compensated value for a monitored value.
